(19) United States
(12) Patent Application Publication
(10) Pub. No.: US 2021/0283871 A1
(43) Pub. Date: Sep. 16, 2021

(54) METHOD FOR FABRICATING LENSES

(71) Applicant: THE AUSTRALIAN NATIONAL UNIVERSITY, Acton (AU)

(72) Inventors: Woei Ming LEE, Scullin, Australian Capital Territory (AU); Zijian CEN, MacGregor, Australian Capital Territory (AU); Tao XU, Turner, Australian Capital Territory (AU)

(21) Appl. No.: 16/330,681

(22) PCT Filed: Sep. 1, 2017
(86) PCT No.: PCT/AU2017/000180

§ 371 Date: Mar. 5, 2019

(30) Foreign Application Priority Data
Sep. 6, 2016 (AU) 2016903569

(51) Int. Cl. B29D 11/00; B29C 41/36; B29L 11/00

(52) U.S. Cl. CPC B29D 11/00365; B29L 2011/0016; B29C 41/36; B29D 11/00442

(57) ABSTRACT

An aspect of the present disclosure provides a method of fabricating a lens using gravity. The method comprises depositing a first transparent solution on an underside of a flat smooth material. Cross-linking of the deposited first transparent solution is then activated to form a support layer. A second transparent solution is deposited onto the surface of the support layer. Cross-linking of the second transparent solution is then activated.

### TECHNICAL FIELD

The present invention relates generally to the fabrication of lenses and, in particular, to mouldless fabrication of a lens using gravitational force, surface tension and capillary action.

### BACKGROUND

Existing methods for fabricating lenses (e.g., mechanical polishing, soft mould with lithography, stamping, etc.) often involve a series of pre-fabrication steps that extends fabrication time and requires complex machinery. Such lens fabrication techniques potentially could also waste significant amounts of raw materials through excessive polishing and use of multiple moulds. These techniques do not allow direct alteration of the lens shape during manufacturing and only allow lenses of a certain focal length to be produced at a time.

There are also mouldless fabrication techniques with the capability of controlling the shape of the manufactured lenses. The crux of mouldess fabrication is the need to control the shape of the lens droplet during fabrication. Many commercial mouldless fabrication techniques typically rely on photo-curable liquid droplets to fabricate the lenses, which require a printing dispenser with complicated opto-mechanical and fluidic parts for depositing smooth lens droplet and obtaining optimal droplet size for curing. The printing dispenser is therefore costly, which in turn reduces the cost effectiveness of these mouldless fabrication techniques. In addition, existing rapid photocured lenses have shown yellowing effects that could reduce transparency of the manufactured lenses.

Thus, there is a need for a simple and high-throughput method for fabricating lenses, which also reduces or eliminates waste of raw materials and/or use of moulds.

### SUMMARY

Disclosed is a lens fabrication technique which seeks to address one or more of the above problems. The lens fabrication technique aims to provide a direct deposit and cross-link activation (i.e., curing) of single to multiple droplets of transparent solution (e.g., polydimethylsiloxane (PDMS), photocuring polymer, UV-activated cross-link polymer (such as Norland Optical Adhesive 60, UV-PMMA), and Hydrogel (such as pohyethylene glycol-based hydrogels)) on the underside of a smooth, flat material (e.g., a glass slide, a silicon wafer, a ceramic slide, etc.). Such a fabrication technique enables each droplet to maximise and retain its parabolic shape. Subsequent droplets on a cross-link activated (i.e., cured) droplet provide additional layers of transparent solution to alter the focal-length, the diameter and the asphericity of the fabricated lens. The above lens fabrication technique uses an inverted injection device, which can be operated with a variety of injection cylindrical tubes to control the volume of each droplet of the highly transparent material being deposited.

The disclosed lens fabrication technique therefore provides accurate control of the shape of each droplet being deposited on the flat material in a rapid fashion.

There is also disclosed an overflow method capable of altering the periphery of the fabricated lens to reduce spherical and marginal aberrations to produce a lens (akin to an aspherical lens) with a consistent image resolution over its given field of view. The overflow method is achieved by depositing a larger droplet, using an injection tube with a larger inner diameter, onto a smaller cured droplet (i.e., the fabricated lens). The larger droplet of the transparent solution forms a clear meniscus over the periphery sections of the fabricated lens, which is likely due to capillary action.

According to a first aspect of the present disclosure, there is provided method of fabricating a lens using gravity. The method comprises depositing a first transparent solution on an underside of a flat smooth material; activating cross-linking of the deposited first transparent solution, the cross-link activated first transparent solution forming a support layer; depositing a second transparent solution onto the surface of the support layer; and activating cross-linking of the second transparent solution.

According to a second aspect of the present disclosure, there is provided a system of fabricating a lens using gravity. The system comprises: means for depositing a first transparent solution on an underside of a flat smooth material; means for activating cross-linking of the deposited first transparent solution, the cross-linked activated deposited transparent solution forming a support layer; means for depositing a second transparent solution onto the surface of the support layer; and means for activating cross-linking of the second transparent solution.

Other aspects of the present disclosure are also disclosed.

### BRIEF DESCRIPTION OF THE DRAWINGS

At least one embodiment of the present invention is described with reference to the drawings, in which:

FIG. 1A shows a spherical lens and an aspherical lens;

FIG. 1B shows the light rays of the spherical lens and the aspherical lens;

FIGS. 1C and 1D show the fields of view of the spherical lens and the aspherical lens, respectively;

FIG. 2 is a flow diagram of a method for fabricating the lens of FIGS. 1A and 1B;

FIG. 3A shows a block diagram of an example setup for fabricating the lens according to the method of FIG. 2;

FIGS. 3B and 3C show an implementation of the setup shown in FIG. 3A;

FIGS. 3D to 3F show block diagrams illustrating a step of the method of FIG. 2;

FIGS. 3G and 3H show photographs of lenses fabricated using the method of FIG. 2;

FIGS. 4A to 4C show three set of lenses fabricated at different heating intervals according to the method of FIG. 2;

FIGS. 5A to 5J show the steps of altering a spherical lens using an overflow method to create lens asphericity to obtain the optical performance of aspherical lenses;

FIG. 6 shows fabricated lenses using the method of FIG. 2;

FIG. 7 shows lenses fabricated when the slide is pre-heated;

FIG. 8 shows a high aspect ratio lens produced using a pre-heated slide;

FIG. 9A shows a lens produced without pre-heating the slide; and

FIG. 9B shows a lens produced by pre-heating the slide.

### DETAILED DESCRIPTION

Where reference is made in any one or more of the accompanying drawings to steps and/or features, which have the same reference numerals, those steps and/or features have for the purposes of this description the same function(s) or operation(s), unless the contrary intention appears.

The terms “cross-link activation”, “activating cross-link” and “curing” have the same meaning and are used interchangeably in the present disclosure.

Disclosed is an embodiment of the invention providing a mouldless lens fabrication method combining layering and gravity, which efficiently utilizes raw material with little wastage. The disclosed lens fabrication method is also capable of controlling the shape of the lens during manufacturing to produce lenses of varying focal length, spherical, marginal and optical aberrations.

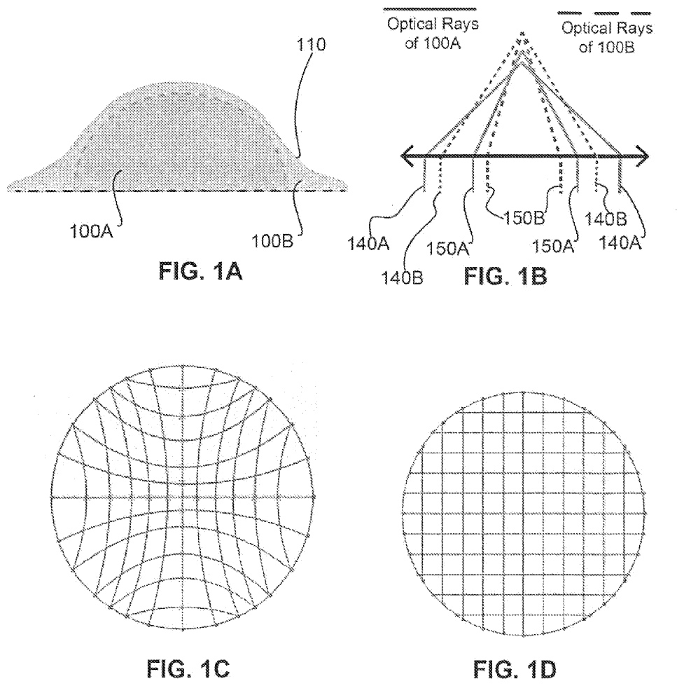

FIG. 1A shows the cross-section of a spherical lens 100A and an aspherical lens 100B. FIG. 1B illustrates paths of optical rays 140A, 140B, 150A, and 150B as each of those rays 140A, 140B, 150A, and 150B passes through the spherical lens 100A and the aspherical lens 100B. For the spherical lens 100A_the marginal light rays 140A passing through the periphery of the lens 100A and central light rays 150A passing through the centre of the lens 100A do not converge at the focus of the lens 100A. On the other hand, the optical rays 140B and 150B of the aspherical lens 100B converge at the focus of the lens 100B.

FIG. 1C displays an example of an optical aberration of non-flatness of the field of view of the spherical lens 100A, resulting from the non-convergence of the marginal light rays 140A and the central light rays 150A. The aspherical lens 100B on the contrary produces a flatness of the field of view as shown in FIG. 1D because of the convergence of the marginal light rays 140B and the central light rays 150B.

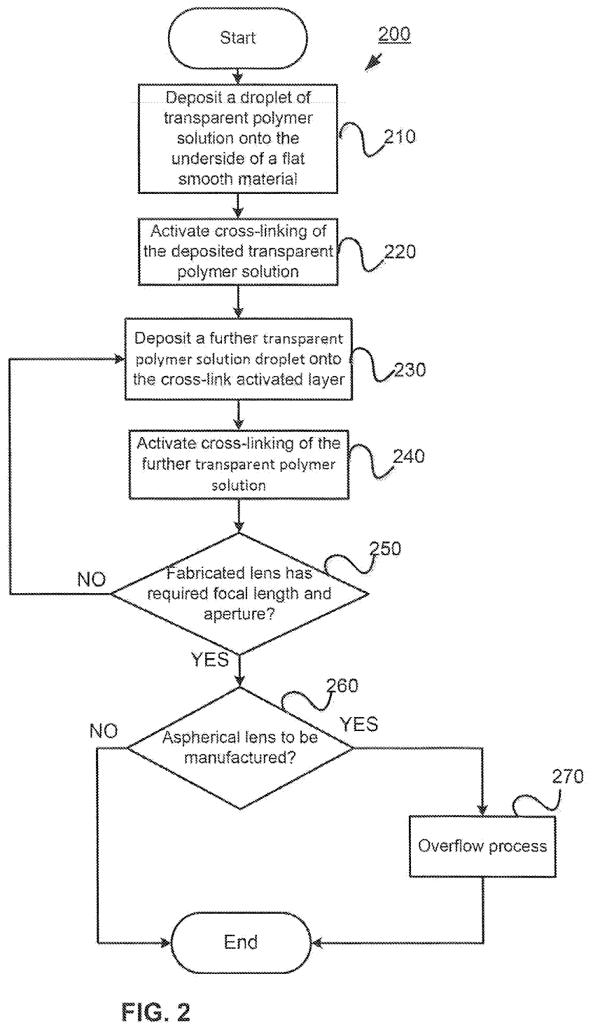

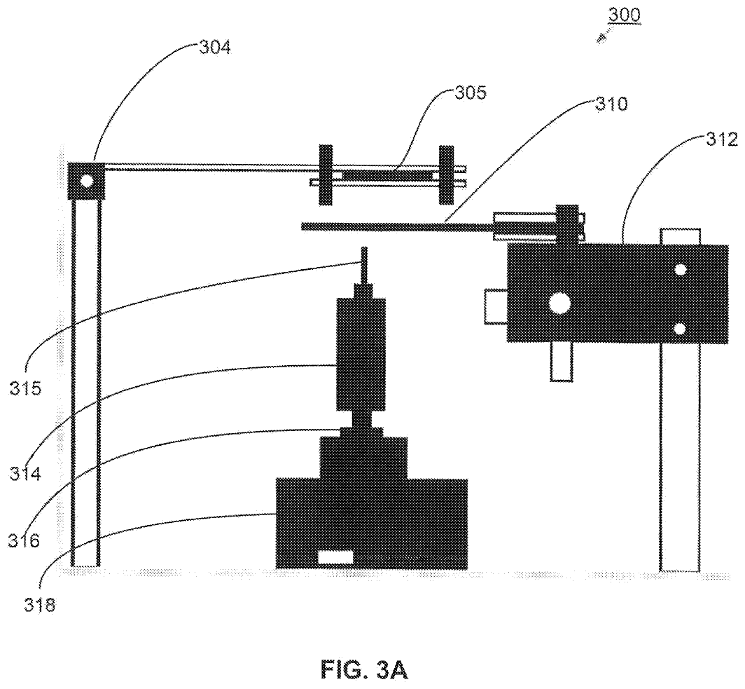

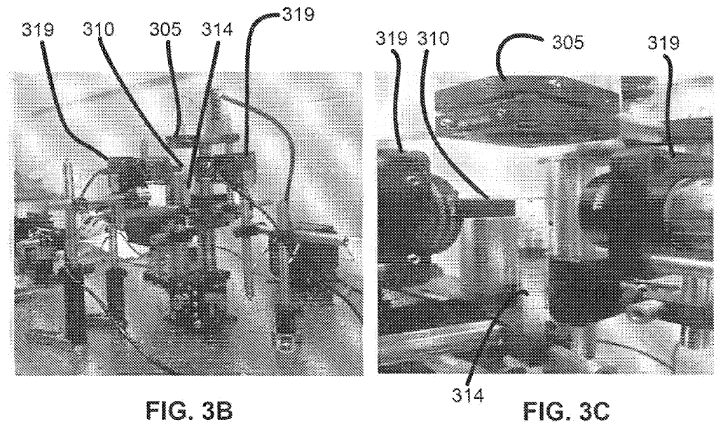

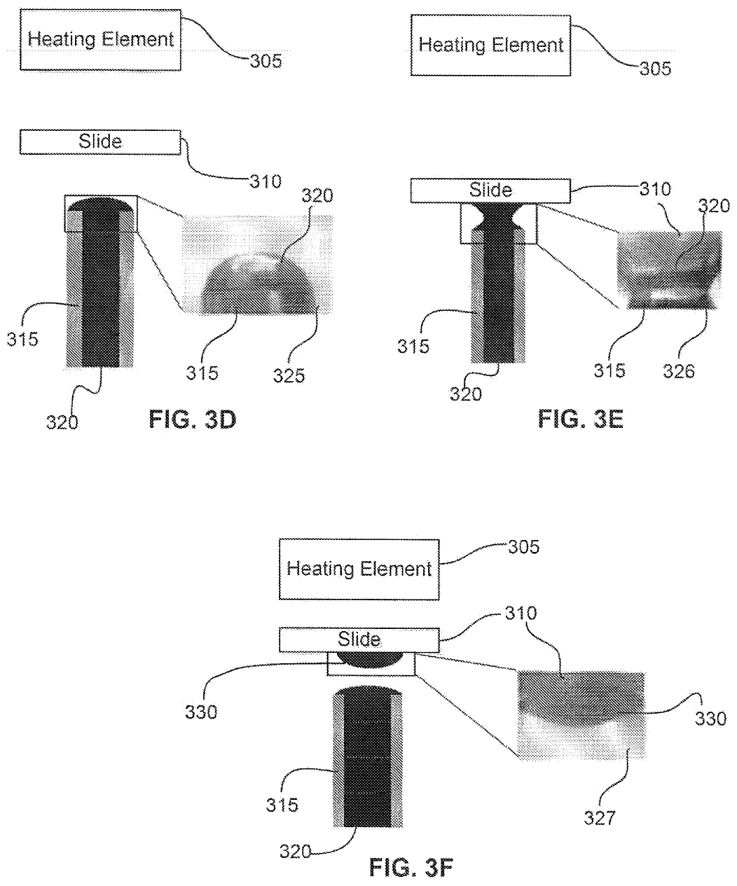

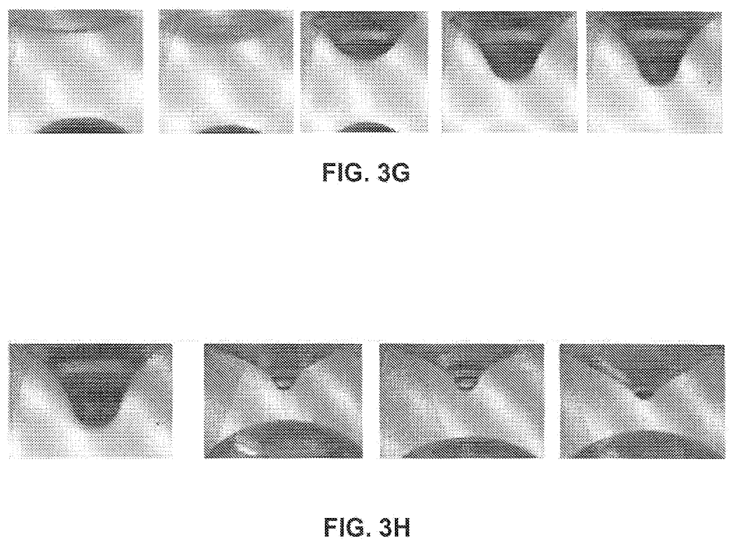

FIG. 2 shows a flow diagram for a method 200 for fabricating the spherical lenses 100A and 100B. The method 200 will be described herein using an example setup 300 shown in FIG. 3A, where the setup 300 was designed to manufacture lenses using thermally activated cross-linking polymers (e.g., PDMS). However, other setups dependent on the curing method of the polymers may also be used to implement the method 200. Examples of other polymers include photosensitive cross-linked polymer such as UV-curing polymer (such as Norland Optical Adhesive 60, UV-PMMA), Hydrogel (such as polyethylene glycol-based hydrogel), and silicone polymers (such as polymers based on Me2SiO2/2 or D units). Further, the polymers are typically transparent over a broadband of light wavelength from UV to Near Infrared. The method 200 can be performed with setups that differ from the setup 300.

The functions of each of the components in the setup 300 will now be described before describing the implementation of the method 200 on the setup 300.

FIG. 3A shows a block diagram of the example setup 300 for implementing the method 200. FIGS. 3B and 3C show pictures of the setup 300 being implemented in a well-controlled laboratory. FIGS. 3D to 3F provide illustrations of step 210 (shown in FIG. 2) of the method 200.

The setup 300 includes a heating element 305, a slide 310, and a droplet injection unit having an ejection unit 318 and a flat tip syringe 314. The syringe 314 includes a flat tip 315 and a plunger 316. The syringe 314 contains a transparent polymer solution 320 (see FIG. 3B) such that when the plunger 314 is pushed into the body of the syringe 314 by the ejection unit 318, then the transparent polymer solution 320 is expelled from the flat tip 315 to form a pool of the transparent polymer solution 320 on the flat tip 315. The size of the fabricated lens 100A is directly controlled by the radius of the flat tip 315, which is typically fine (e.g., about 21 gauge thickness). One example of the transparent polymer solution 320 suitable for use in the setup 300 is the PDMS. For the overflow method (see step 270 of the method 200), the diameter of the flat tip 315 is increased in order to deposit a larger droplet (e.g. gauge thickness of 30 to 31).

In one example, a highly transparent polymer solution 320 is created by mixing a silicone base with a curing agent in a typically 10:1 ratio, as measured by weight. The mixing of the transparent polymer solution 320 is typically performed by using a Q-tip or other mixing devices. The mixed transparent polymer solution 320 is allowed to rest, removing trapped bubbles (e.g., by using a desiccator or a vacuum pump) during stirring, before the transparent polymer solution 320 is inserted into the syringe 314. One example method of inserting the transparent polymer solution 320 into the syringe 314 include plunging the tip 315 of the syringe 314 into the transparent polymer solution 320 and pulling the plunger 316 out of the body of the syringe 314 so that the transparent polymer solution 320 is drawn into the body of the syringe 314.

The heating element 305 is secured to a device 304 and located above the slide 310. In the setup 300, the heating element 305 used is a ceramic heating substrate that is powered by a 24V DC electrical power source and has a maximum temperature of 120° C. However, other heating elements such as a heat lamp may also be used. Further, other heating elements capable of a higher maximum temperature can also be used. For photocuring solution 320, UV lamp is used to cross-link the solution 320 and a setup different to the setup 300 would be required.

The slide 310 is secured onto a device 312 which has three degrees (XYZ) of freedom of movement that enables the slide 310 to be moved without changing the angle of the slide 310. The slide 310 is aligned on top of the flat tip 315 of the syringe 314. During the lens fabrication process, the device 312 enables the slide 310 to be lowered onto the pool of transparent polymer solution 320 on the flat tip 315 and raised to the heating element 305 to thermally activate the cross-linking of the solution 320. The position of the slide 310 from the heating element 305 is changed during the cross-linking thermal activation to ensure controlled heating of the solution 320.

In another arrangement, the slide 310 is fixed and the syringe 314 is movable, so that the syringe 314 can be raised to the slide 310 to deposit the pool of transparent polymer solution 320 on the flat tip 315 onto the underside of the slide 310.

The slide 310 is made of materials having a surface that is chemically inert and has low surface roughness (i.e., less than a tenth of a wavelength of visible light, which is around 50 nm), such as glass. The slide can be made up of material with an optically smooth surface such as a silicon wafer, a ceramic slide, and the like.

The mechanical plunger 318 of the syringe 314 containing the solution 320 is aligned flat to the ejection system 318. The ejection system 318 operates the mechanical plunger 316 to control the amount of the transparent polymer solution 320 being expelled from the flat tip 315 to form the pool of the transparent polymer solution 320, which is ultimately deposited onto the slide 310.

To ensure that the slide 310 and the flat tip 315 are parallel to each other, an orthogonal microscopic inspection system 319 (shown in FIGS. 3B and 3C) is used to monitor the slide 310 to ensure that the slide 310 is not tilted (i.e., level) and that the deposit of the transparent polymer solution 320 onto the underside of the slide 310 is precise. FIGS. 3D to 3F, 4A to 4C, and 5C to 5J show images taken using the orthogonal microscopy system 319.

The discussion now turns to the method 200 where the method 200 commences after the transparent polymer solution 320 has been prepared and inserted into the syringe 314.

The method 200 commences with step 210 where a droplet of the transparent polymer solution 320 is deposited onto the underside of a flat smooth material (i.e., the slide 310). This step is shown in FIGS. 3D to 3F, where a pool of the transparent polymer solution 320 in aqueous state is formed on the flat tip 315. FIG. 3D shows a photograph 325 displaying a pool of the transparent polymer solution 320 on the flat tip 315 because of the high viscosity and high surface tension of the transparent polymer solution 320. The expelling of the transparent polymer solution 320 from the flat tip 315 is performed by the ejection system 318, as described hereinbefore. The diameter of the flat tip 315 determines the surface area where the transparent polymer solution 320 is deposited, which in turn determines the area of the support layer 330 which also determines the diameter and hence the aperture the fabricated lens 100A.

FIG. 3E shows the slide 310 being lowered by the device 312 onto the flat tip 315, such that, upon contact between the transparent polymer solution 320 and the pool of the transparent polymer solution 320, the pool of the solution 320 is attracted to the underside of the slide 310. FIG. 3E also displays a photograph 326 showing the depositing of the transparent polymer solution 320 onto the underside of the slide 310 from the flat tip 315. During contact between the slide 310 and the transparent polymer solution 320, the slide 310 is held in position for a predetermined amount of time depending on the heat applied by the heating element 305. When the transparent polymer solution 320 on the underside of the slide 310 spreads on the slide 310 and stops moving, the slide 310 is raised away from the flat tip 315. In one example, the slide 310 is held in position for a period of time between 1 and 7 seconds while the heating element 305 is set to a temperature of about 150° C. The slide 310 is arranged horizontally relative to the ground during the depositing of the solution 320 onto the slide 310, enabling the deposited solution 320 to spread consistently in all directions on the slide 310. The inspection system 319 is used to ensure that the slide 310 is not tilted in any one direction to ensure the consistent spread of the transparent polymer solution 320.

FIG. 3F shows the slide 310 being raised by the device 312. A large portion of the solution 320, which was on the flat tip 315, is transferred onto the underside of the slide 310 to form a support layer 330. FIG. 3F also shows a photograph 330 of the support layer 330 being formed on the underside of the slide 310.

In one arrangement, the slide 305 is pre-heated before commencing with step 210. The pre-heating can be performed by placing the slide 310 on the heating element 305, which is set at a temperature (e.g., 200° C.), for a period of time (e.g., 10 minutes). This enables the slide 310 to be pre-heated to a certain temperature. The pre-heating of the slide 310 is applicable when the cross-linking of the transparent polymer solution 320 is thermally activated.

Once the slide 310 is pre-heated to a defined temperature (e.g., 200° C.), then step 210 is performed where the slide 310 is lowered onto the pool of transparent polymer solution 320 on the flat tip 315 until the solution 320 is deposited on the underside of the slide 310. In an alternative arrangement, once the slide 310 is pre-heated, the syringe 314 is raised to the slide 310 to deposit the pool of transparent polymer solution 320 on the flat tip 315 onto the underside of the slide 310.

As described hereinbefore, the diameter of the flat tip 315 determines the surface area where the transparent polymer solution 320 is deposited. The following table shows examples of sizes of the support layer 330 with different diameters of the flat tip 315 when the slide 310 is pre-heated to a temperature of 200° C.:

| Outer Diameter of the | Diameter of the support |
|---|---|
| flat tip 315 (mm) | layer 330 (mm) |
| 1 | 0.546 |
| 1.5 | 0.762 |
| 2 | 1.25 |

The method 200 then proceeds to step 220, where cross linking of the deposited solution 320 is activated (i.e., the deposited solution 320 is solidified). In the setup 300, the support layer 330 (i.e., the deposited transparent polymer solution 320) is cross-link activated through heating at a predetermined temperature for a predetermined amount of time. In this step, the slide 310 is raised to the heating element 305 so that the heat from the heating element 305 activates the molecules cross-linking in the solution 320 to form the support layer 330. The separation between the slide 310 and the heating element 305 is adjustable to ensure optimal cross-linking activation of the support layer 330. As can be seen in FIG. 3F, the heating element 305 is placed on the side of the slide 310 opposite to the underside of the slide 310 where the solution 320 is deposited. The heating element 305 is set at a temperature in the range of 70° C. to 120° C. to activate the cross-linking. The slide 310 is placed closed to the heating element 305 for a predetermined amount of time of 30 seconds to 1 minute to allow the cross-linking activation to occur.

In the alternative arrangement where the slide 310 is pre-heated, the cross-linking occurs as soon as solution 320 is deposited on the slide 310.

Once the support layer 330 is cross-link activated, the method 200 proceeds to step 230.

In step 230, a droplet of further transparent polymer solution 320 is deposited onto the support layer 330. Step 230 is similar to step 210 described above. The slide 310 is lowered by the device 312 so that the support layer 330 is in contact with the pool of the transparent polymer solution 320 on the flat tip 315. The contact and subsequent separation between the support layer 330 and the pool of transparent polymer solution 320 result in a large portion of the transparent polymer solution 320 being transferred onto the support layer 330. The method 200 then proceeds to step 240.

In step 240, the further transparent polymer solution 320 is cross-link activated. Step 240 is similar to step 220 described above. The slide 310 is raised by the device 312 so that the heat from the heating element 305 activates cross-linking of the further deposited solution 320. As described hereinbefore, the heating element 305 can be set at a temperature of 70° C. to 120° C. for a period of 30 seconds to 1 second to activate the cross-linking of the further deposited transparent polymer solution 320 to ensure that minimal wetting property result for the support layer 330. Minimal wetting property means that less of the transparent polymer solution 320 being deposited onto the support layers 330 flows onto the apex of the support layer 330 and more of the transparent polymer solution 320 is being retained by the sides of the support layer 330. In other words, minimal wetting property enables the deposited transparent polymer solution 320 to retain the shape of the support layer 330, thereby retaining the sphericity of the lens 100A produced by the steps 210 to 240. Therefore, the curvature and aperture of the fabricated lens 100A can be controlled by controlling the cross-linking activation times of the solution 320. The method 200 proceeds to step 250.

In step 250, the fabricated lens 100A is checked to determine whether the lens 100A has the required focal length. If not (NO), then step 250 proceeds to step 230 and the process of steps 230 and 240 are repeated to add further layers to the lens 100A. Otherwise (YES), the method 200 proceeds to step 260.

By repeating the process of steps 230 and 240, further transparent polymer solution 320 is deposited on the cured support layer 330. In one arrangement, different solution 320 is being used for each repetition of steps 230 and 240, thereby resulting in a graded index of the manufactured lens 100A. In the arrangement where a graded index lens is manufactured, modified silicone polymer can be used for each layer to change the refractive index of the manufactured lens 100A. Some examples of the modified silicone polymer are polymer where the methyl groups along the polymer chain are substituted with phenyl groups to increase the refractive index to approximately 1.55 or with trifluoropropyl groups to reduce the refractive index below 1.40.

FIG. 3G shows multiple layers being deposited which reduces the radius of curvature (from the leftmost picture to the rightmost picture) when steps 230 and 240 are being repeated.

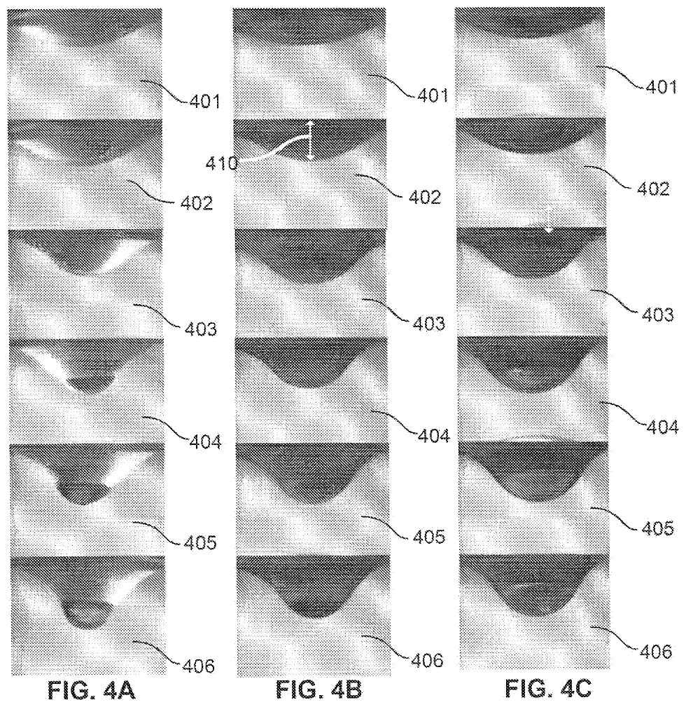

FIGS. 4A to 4C show a comparison of three different lenses 100A, especially the formation of the support layer 330 on the slide 310, when the solution 320 on the slide 310 are cured at the same temperature but with different heating time. The longer the curing time, the less wetting property the surface of the support layer 330 possesses.

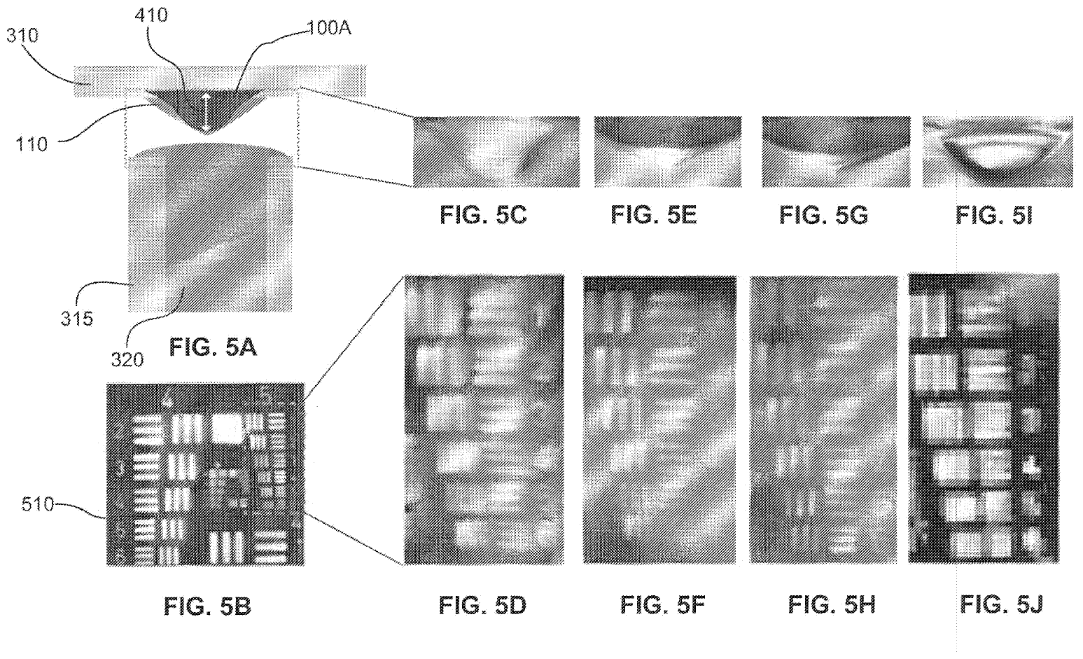

FIGS. 4A to 4C show the spherical lenses 100A being fabricated with a heating time of 30 seconds, 15 seconds, and 5 seconds, respectively. Picture 401 in each of FIGS. 4A to 4C shows the support layer 330 with 1 additional layer of solution 320 being cured on the support layer 330. Pictures 402 to 406 in each of FIGS. 4A to 4C display the support layer 330 with 2 to 6 additional layers of solution 320 being cured on the support layer 330, respectively. FIGS. 4A to 4C show that that heating (curing) time changes the height of the fabricated lens over a fixed number of layering step changes the focal length of the lenses. When the heating time is fixed at 30 seconds, the depth of the lens (shown in FIG. 5A) at the apex of the lens has a smaller radius of curvature and also a smaller aperture when compared to the lenses fabricated at the heating time of 15, FIG. 5B, and 5 seconds, FIG. 5C, respectively.

FIG. 4A shows that with increasing amount of deposit of the transparent polymer solution 320 onto the support layer 330, the lens 100A has with a large aspect ratio of diameter versus depth with a strong parabolic curvature. Such a parabolic shape has the above-discussed non-convergence of central and marginal light rays as discussed above in relation to FIG. 1A. Whilst capillary flow (i.e., upward fluid flow) along the lenses 100A can be seen, it does not reduce the marginal aberrations.

In step 260, the method 200 determines whether an aspherical lens 100B is to be manufactured. If not (NO), then the method 200 concludes. If yes (YES), then the method 200 proceeds to step 270.

In step 270, an overflow process is performed. An overflow process is a repeat of steps 230 to 250 using a flat tip 315 of larger diameter than the flat tip 315 used for the steps 230 to 250. The larger diameter flat tip 315 for the overflow process results in a pool of transparent polymer solution 320 that is larger than the pool of transparent polymer solution 320 used in step 210 or 230. The larger pool of the transparent polymer solution 320 results in larger deposit of the solution 320 on the support layer 330. The larger deposited transparent polymer solution 320 flows more easily toward the apex of the support layer 330, thereby creating the aspherical lens 100 when the transparent polymer solution 320 is cross-link activated. Each deposit of the larger droplet of transparent polymer solution 320 onto the support layer 330 modifies the periphery of the manufactured lens 100B such that the convex 110 of the lens 100B is gradually modified from steep to gentle. Further, the overflow process retains the magnification of the manufactured lens 100A and at the same time increases the flatness field of view (shown in FIG. 1D) to achieve optimal imaging results.

The overflow process arises from capillary action and low wettability of the surface where a thin meniscus fills the peripheral of the support layer 330. The thin meniscus adheres along the side and the apex of the support layer 330 to create a parabolic shape 110, such that the fabricated aspherical lens 100B is comparable to an ideal aspherical lens. FIG. 3H shows an example of the aspherical lens 100B being formed by the overflow process of step 270 where the diameter of the flat tip 315 is increased to a gauge thickness of 30 to 31, as described hereinbefore. The method 200 then concludes.

When implementing the method 200 on the setup 300, it is also possible to create different lenses on the same flat smooth material. For example, one lens may be manufactured using a syringe 314 with a flat tip 315 of a first diameter, while another lens may be manufactured with another syringe 314 where the flat tip 315 is larger or smaller. In another example, one portion of the flat smooth material may be heated at a first temperature, while another portion is heated at a second temperature. In another example, the heating time may be different at different portions of the flat smooth material.

FIG. 5A illustrates a fabricated lens 100A, which was constructed with 6 layers, on the slide 310. The fabricated lens 100A (fabricated using steps 210 to 250) is overflowed with transparent solution 320 (fabricated using step 270) by fully immersing the fabricated lens 100A into the solution 320 that is on a larger flat tip 315.

FIG. 5B shows an image of the focus of a polymer aspherical lens for comparison with the manufactured aspherical lens 100B.

FIGS. 5C, 5E, 5G, and 5I show the fabricated lens 100A undergoing the overflowing process of step 270 zero time (0 overflow layer), one time (1 overflow layer), two times (2 overflow layer), and three times (3 overflow layer), respectively. FIGS. 5D, 5F, 5H, and 5J show the focusing of the lenses of FIGS. 5C, 5E, 5G, and 5I, respectively.

FIGS. 5D, 5F, 5H, and 5J show that the overall magnification of the lens 100B is retained with each overflow layer without reducing the resolution. However, excess overflow layer results in the lens reverting to a lens of lower resolving power.

The advantages of the lens-fabrication method 200 are the simplicity and reproducibility of the manufacturing method. The lens-fabrication method 200 also minimises lens defect that typically exists in existing lens-fabrication methods due to asymmetry or deformation of the moulds used. Furthermore, a lens 100A or 100B fabricated using the method 200 can be shaped to achieve different focal lengths and different flatness of field of view. Lenses of differing magnification can be used for different purposes, e.g. imaging and collimation.

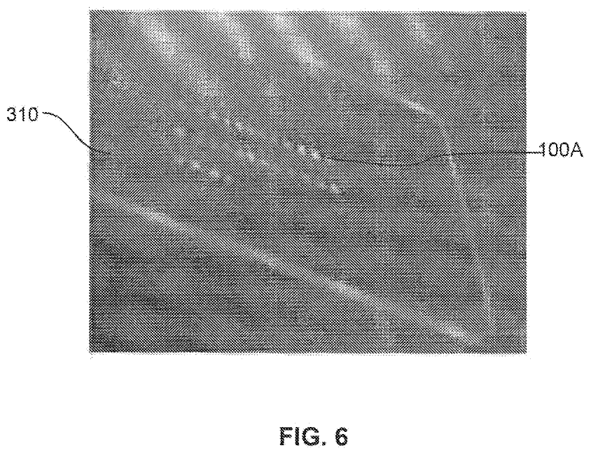

FIG. 6 shows the fabrication of multiple lenses 100A using the method 200 on the slide 310. Each of the lenses 100A shown in FIG. 6 has a diameter of 0.66 mm, which corresponds to the diameter of the flat tip 315 used.

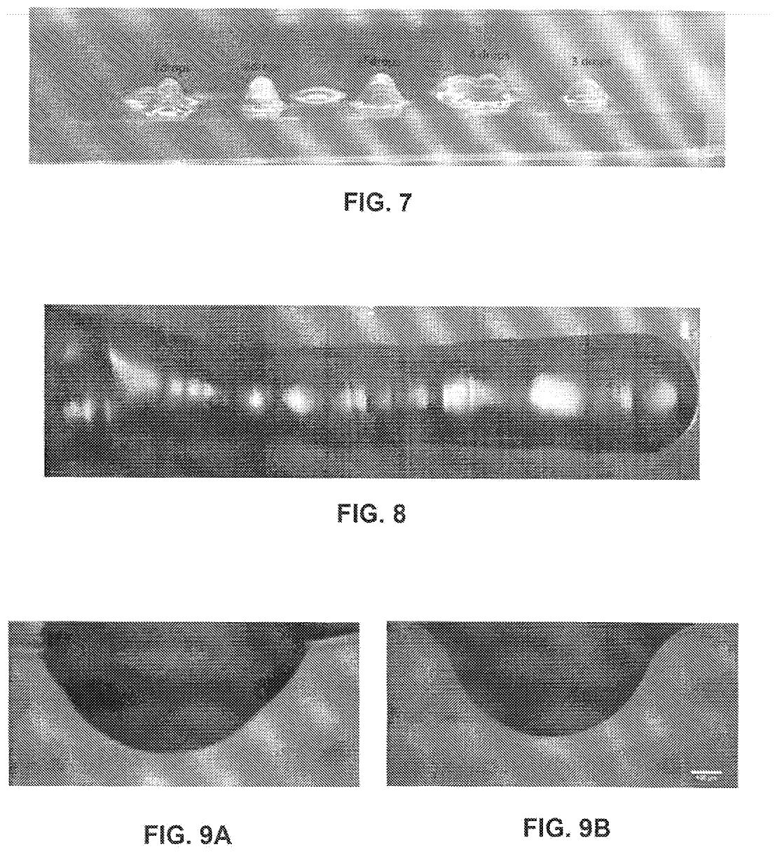

FIG. 7 shows a number of lenses 100A that were fabricated using the pre-heating arrangement, where the slide 310 was pre-heated to 200° C., with a different number of droplets deposited on the support layer 330 for each lens. It was experimentally observed that the height of the lens can be tailored to a highly asymmetrical aspect ratio using the pre-heating arrangement.

FIG. 8 shows a high aspect ratio lens 100A that was produced by using the pre-heating arrangement. The lens 100A shown in FIG. 8 was fabricated using 76 droplets of the solution 320. The lens 100A has a base of 0546 mm and a height of 2.072 mm. Such a lens having a high aspect ratio cannot be produced without the pre-heating arrangement.

FIGS. 9A and 9B show lenses 100A produced without and with the pre-heating arrangement being used, respectively. The lens 100A shown in FIG. 9A was fabricated from a droplet of the solution 320 that was cured 5 minutes after the droplet was deposited on the slide 310. On the other hand, the lens 100A shown in FIG. 9B was also fabricated from a droplet of the solution 320 when the slide 310 was pre-heated. As can be seen from FIGS. 9A and 9B, the lens 100A shown in FIG. 9B (which was fabricated using the pre-heating arrangement) retains a more uniform shape, which is closer to being aspherical.

### INDUSTRIAL APPLICABILITY

The arrangements described are applicable to the lens manufacturing industries.

The foregoing describes only some embodiments of the present invention, and modifications and/or changes can be made thereto without departing from the scope and spirit of the invention, the embodiments being illustrative and not restrictive.

In the context of this specification, the word “comprising” means “including principally but not necessarily solely” or “having” or “including”, and not “consisting only of”. Variations of the word “comprising”, such as “comprise” and “comprises” have correspondingly varied meanings.

1. A method of fabricating a lens using gravity, the method comprising:
depositing a first transparent solution on a flat surface of a smooth material, the flat surface being disposed on an underside of the smooth material, wherein all of the deposited first transparent solution is on the flat surface;
activating cross-linking of the deposited first transparent solution, the cross-link activated first transparent solution forming a support layer;
depositing a second transparent solution onto the surface of the support layer; and
activating cross-linking of the second transparent solution.

2. The method as claimed in claim 1, wherein the depositing of the first or second transparent solution comprises the steps of:
lowering the flat surface onto a first pool of the first or second transparent solution;
holding the flat surface in the lowered position until the first pool stops spreading on the flat smooth material; and
raising the flat surface away from the first pool.

3. The method as claimed in claim 1, wherein the depositing of the first or second transparent solution comprises the steps of:
raising a first pool of the first or second transparent solution onto the flat surface;
holding the first pool until the first pool stops spreading on the flat surface; and
moving the first pool away from the flat surface.

4. The method as claimed in claim 1, comprising altering the shape of lens to reduce the focal length of the lens by repeatedly:
depositing further transparent solution onto the support layer; and
activating cross-link of the deposited further transparent solution.

5. The method as claimed in claim 2, wherein the quantity of the first transparent solution deposited on the flat surface determines the size of the support layer thereby determining the size of the fabricated lens.

6. The method as claimed in claim 2, wherein the first pool is formed on a flat tip of a first injection device.

7. The method as claimed in claim 1, wherein the flat surface is held horizontally relative to the ground.

8. The method as claimed in claim 1, wherein the transparent solution is any one of the following:
polydimethylsiloxane (PDMS);
photocuring polymer;
UV-activated cross-link polymer; and
hydrogel.

9. The method as claimed in claim 1, wherein the flat surface is any one of a glass slide, a silicon wafer, and a ceramic slide.

10. The method as claimed in claim 2, the method further comprising:
lowering the flat surface onto a second pool of the first or second transparent solution so that the support layer is immersed in the second pool;
raising the flat surface away from the second pool; and
activating cross-linking of the first or second transparent solution deposited on the support layer by the second pool, wherein the second pool is larger in diameter than the first pool.

11. The method as claimed in claim 3, the method further comprising:
raising a second pool of the first or second transparent solution to the flat surface so that the support layer is immersed in the second pool;
moving the second pool away from the flat surface; and
activating cross-linking of the first or second transparent solution deposited on the support layer by the second pool, wherein the second pool is larger in diameter than the first pool.

12. The method as claimed in claim 10, wherein the second pool is formed on a flat tip of a second injection device, wherein the flat tip of the second injection device is larger in diameter than the flat tip of the first injection device.

13. The method as claimed in claim 1, wherein the cross-linking of the transparent solution is activated thermally, the method further comprising:
heating the flat surface to a predefined temperature before depositing the first transparent solution on the underside of the flat smooth material.

14. A system of fabricating a lens using gravity, the system comprising:
means for depositing a first transparent solution on a flat surface of a smooth material, the flat surface being disposed on an underside of the smooth material, wherein all of the deposited first transparent solution is on the flat surface;
means for activating cross-linking of the deposited first transparent solution, the cross-linked activated deposited transparent solution forming a support layer;
means for depositing a second transparent solution onto the surface of the support layer; and
means for activating cross-linking of the second transparent solution.

15. The system as claimed in claim 14, wherein the means for depositing the first transparent solution or the second transparent solution comprises:
a first device for securing and moving the flat surface; and
a second device for forming a first pool of the first or second transparent solution, wherein
the first device lowers the flat surface onto the first pool, holds the flat surface in the lowered position until the first pool stops spreading on the flat surface, and raises the flat surface away from the first pool.

16. The system as claimed in claim 15, wherein the second device is a flat tip of an injection device.

17. The system as claimed in claim 14, wherein the means for activating cross-linking comprises a heating element placed on the side of the flat surface opposite to the underside where the first transparent solution is deposited.

18. The system as claimed in claim 14, wherein the flat surface is any one of a glass slide, a silicon wafer, and a ceramic slide.

19. The system as claimed in claim 14, wherein the first or second transparent solution is any one of the following:
polydimethylsiloxane (PDMS);
photocuring polymer;
UV-activated cross-link polymer; and
hydrogel.

20. The system as claimed in claim 14, further comprising:
a third device for forming a second pool of the first or second transparent solution, wherein the second pool is larger in diameter than the first pool.

21. The system as claimed in claim 20, wherein the third device is a flat tip of an injection device.

22. The system as claimed in claim 14, wherein the cross-linking of the transparent solution is activated thermally, the system further comprising:
means for heating the flat surface to a predefined temperature before depositing the first transparent solution on the flat surface.

23. A lens fabricated using the method as claimed in claim 1.
